(19) United States
(12) Patent Application Publication
(10) Pub. No.: US 2014/0305036 A1
(43) Pub. Date: Oct. 16, 2014

(54) FUNCTIONAL POLYTUNNELS, IN PARTICULAR SELF-ERECTING STRUCTURES AND PROGRAMMING METHODS THEREFOR

(71) Applicants: Thorsten Pretsch, Berlin (DE); Jasmin Lindebacher, Duesseldorf (DE); Juergen Haettig, Odenthal (DE)

(72) Inventors: Thorsten Pretsch, Berlin (DE); Jasmin Lindebacher, Duesseldorf (DE); Juergen Haettig, Odenthal (DE)

(73) Assignees: M Bundesanstalt Fuer Materialforschung und- pruefung, Berlin (DE); Bayer Intellectual Property GmbH, Monheim (DE)

(21) Appl. No.: 14/110,463

(22) PCT Filed: Apr. 5, 2012
(86) PCT No.: PCT/EP2012/056333

§ 371 Date: Jan. 7, 2014

(30) Foreign Application Priority Data
Apr. 8, 2011 (DE) 102011001917.0

(51) Int. Cl. A01G 9/14; B29C 61/00

(52) U.S. Cl. CPC A01G 9/14; B29C 61/00
USPC 47/17; 264/230; 493/393; 425/470

(57) ABSTRACT

A device comprising a planar material and at least one support element which is connected to the planar material, wherein the at least one support element comprises at least one shape memory polymer, such that the device has a substantially flat shape in a first configuration of the at least one shape-memory polymer and a substantially domed shape in a second configuration of the shape-memory polymer.

### BACKGROUND

The present invention relates to apparatuses, particularly polytunnels, and the use of a shape memory polymer for a self-erecting structure of such devices or polytunnels.

A polytunnel can provide protection from precipitation or overnight frost for example, or it can serve to create a favourable microclimate. An apparatus of the type described can also provide protection from direct sunlight.

The erection of conventional polytunnels requires a great deal of labour and time. For conventional polytunnels or poly greenhouses for example, a complete framework consisting of interconnected metal hoops must first be set up first. Only then is the plastic foil pulled over the hoop segments.

### SUMMARY

Against this background, a device comprising a sheet material and at least one support element connected to the sheet material is suggested, wherein the at least one support element comprises at least one shape memory polymer in such manner that in a first configuration of the shape memory polymer the apparatus has a substantially flat shape, and in a second configuration of the shape memory polymer the apparatus has a substantially curved shape.

According to preferred embodiments, the support element, which comprises at least one shape memory polymer (SMP), may be integrated in a plastic foil as a straight form beforehand, or it may be attached to a plastic foil.

In general, the term shape memory polymer is used to designate plastics that apparently “remember” their former external shape after a shape transformation, and to this extent have a shape memory. To recreate the earlier shape, the SMP must be exposed to a stimulus. This stimulus may be the application of heat for example, by heating the SMP in question directly or indirectly.

The SMP may be heated directly from the outside by means of hot air, IR radiation, for example by exposure to sunlight or the air stream from a hot air blower, or by direct contact with a heat storage medium, such as a preheated fluid. According to one embodiment, the heat is supplied via hot water.

According to other embodiments, the heat is supplied indirectly, in that an auxiliary material embedded permanently in the SMP heats the SMP matrix by interacting with an external electromagnetic field. Such auxiliary materials may have a graphene structure, for example, such as exists in graphite, carbon nanotubes, graphene flakes, or expanded graphite. Other particles with a nanoscale dimension may also be used as auxiliary materials.

One advantage of adding auxiliary materials to the SMP is that due to their size and material properties they absorb the energy of irradiating electromagnetic fields, convert it into heat and deliver it to the matrix of the shape memory polymer that surrounds them. In this way, it is possible to ensure effective heating and rapid shape change of a support element made from SMP in a touchless manner.

Heating of the shape memory polymer directly or indirectly causes the support element to change its shape from the temporary to its original, primary form without contact. Said original form is advantageously one that ensures a substantially convex shape of the sheet material attached to the support element. If the sheet material is a foil, the direct or indirect supply of heat results in the curvature of the foil, for example.

If multiple support elements are suitably secured to the sheet material and if such elements have a corresponding orientation, when the shape memory polymer in the support elements regains its original shape a three-dimensional curved surface resembling a wall or upper surface of an arch, a dome, a tunnel or a channel is created. A polytunnel represents a preferred embodiment of the use described here of SMP in the described apparatus.

Other embodiments of the support elements comprise the erection or construction of a substantially planar surface, a wall, a fence or some other type of barrier, enclosure or boundary. The support elements of these embodiments assume an angled shape for example when the SMP component regains its original form. The method of attaching the sheet material to one or more support elements results in a generally upright structure of this embodiment of the apparatus.

The sheet material advantageously has the form of a foil or foil web, such as foils used in the agricultural sector, agricultural foils for example. For other embodiments, a different substantially two-dimensional material such as a textile, fabric, mesh, gauze or non-woven material such as fleece, paper or other latticed, slitted, openwork or otherwise at least partially perforated or continuously closed, planar structure may also be used instead of a foil or foil web.

The foil or other essentially flat material of the apparatus may also have the form of an equilateral or approximately equilateral surface or of an essentially circular surface. The correspondingly prepared foil, equipped with support elements in a straight configuration, or the flat material with at least one support element is laid out, spread out, rolled out, stretched out and/or fastened to the surface that is intended to function as the polytunnel or apparatus.

A change in the configuration of the support element is brought about by the application of heat that is adapted according to the specific properties of the shape memory polymer component of the support element. The nature of the attachment of one or more identical or similar support elements to the foil or sheet material causes the apparatus to take on the intended arched or upright form when the SMP component is heated.

Specific properties of an SMP component are considered to be, for example, the melting temperature and the glass transition temperature (T_{g}) thereof, the crystallization temperature of the soft segments of a block copolymer and the resulting shape-memory properties, such as the extent or degree of return (recovery) achieved, the rate of recovery, the recovery speed and recovery temperature or transition temperature (Tₜᵣₐₙₛ) thereof. Further parameters of the SMP component of the apparatus are for example its modulus of elasticity, hardness, and shear strength. These values are determined for example by the chemical nature of the shape memory polymer or shape memory polymer composite and are known to a person skilled in the art.

In the horticultural sector, polytunnels are used as an inexpensive alternative to greenhouses. Polytunnels used in this context are particularly translucent constructions that enable plants to be cultivated in a protected, controlled environment. Plant protection shelters like said polytunnels are usually made from plastic foils. This ensures that the temperature in the covered area is sufficiently high, while the plastic foil also provides protection from precipitation.

The idea on which the described device is based, that of integrating a shape memory polymer (SMP) that will later assume the desired arched shape of the support element into the plastic foil in a straight form beforehand, can also be transferred to other applications in which a sheet material is held up or retained in a stretched state by stirrups, supports, masts, poles or other supporting elements.

Advantages of the suggested embodiment of load-bearing support elements, for example in the form of poles and tubes of SMP consist in that the shape (including the cross-section thereof) can be adapted to the respective application-specific requirements. This adaptation affects for example the force required to erect or unfold the overall construct, thermomechanical properties, resistance to crosswinds, etc.

For example, load-bearing support elements of “pop-up tents” in the form of poles or tubes made from SMP can be adapted in terms of their dimension and shape (including the cross-section thereof) to the requirements of a given situation. Known pop-up tents can only be used (popped up) up to a limited weight because they quickly become unmanageable. It is also known that cheap variants of pop-up tents can be rendered useless because a pole breaks even as the tent is being set up. Moreover, repairing pop-up tents with broken poles is very expensive.

### BRIEF DESCRIPTION OF THE DRAWINGS

The following is intended to described and explain the proposed principle with reference to the drawing. In the drawing:

FIG. 1 shows basic forms of support elements (permanent configuration of the SMP);

FIG. 2 shows examples of cross-sectional shapes of pole-like support elements;

FIG. 3 shows examples of cross-sectional shapes of tube-like support elements;

FIG. 4 shows examples of the structure of the outer contour of support elements;

FIG. 5 shows the fractal outer contour of support elements in the manner of the Koch snowflake;

FIG. 6 shows the connection of adjacent support elements with spacers;

FIG. 7 shows the programming of support elements according to the “folding door” concept;

FIG. 8 shows the programming of support elements (shape fixing) under load;

FIG. 9 shows the direction and location of forces applied to support elements for shape fixing (programming);

FIG. 10 shows an example of attaching a shape fixed support elements in foil pouches and roll bearing form;

FIG. 11 shows a flat aspect foil on the erection site before and after the shape memory element is triggered;

FIG. 12 shows a cross section through a support element in the corresponding foil pouch;

FIG. 13 shows the recovery behaviour of a material sample of poly(ester urethane) SMP as a function of time.

### DETAILED DESCRIPTION

The load-bearing support elements, such as the poles or tubes of a polytunnel or some other self-erecting structure are made from an SMP. The SMP is then brought into a temporary shape so that it can be inserted in prefabricated pouches of plastic foil or another appropriate planar material. Triggering of the shape memory effect then causes the polytunnel or the apparatus to erect itself automatically. After use, the poles/tubes of SMP are brought back into the linear (temporary) shape by a shape fixing procedure and are then ready to be used again.

In the following, the term “pole” is used to describe an elongated SMP element which has no void. The term “tube” is defined in such manner that the elongated SMP element has at least one void; however, an undetermined number of voids or channels having the same or different diameters or shapes may also exist in the tube. It should be noted that the shape of the voids in a tube is preferably circular or elliptical.

A particularly suitable method for manufacturing the pole- or tube-like support elements described here is the injection moulding technique. Correspondingly adapted profile extrusion processes may also be used.

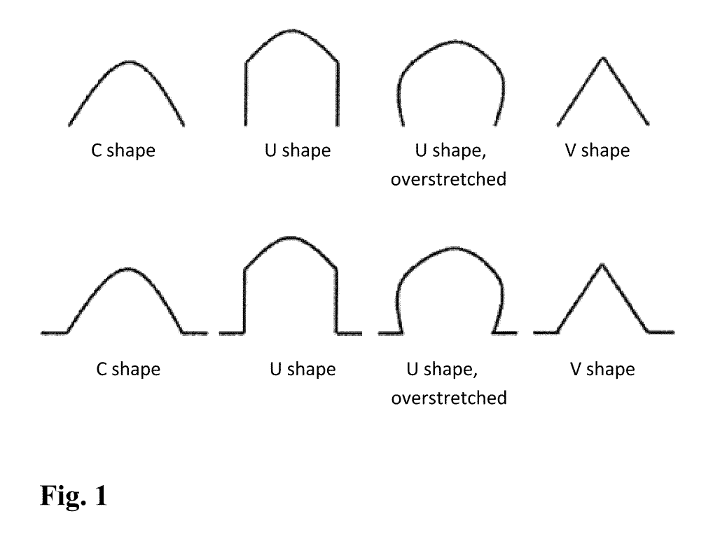

According to one or more embodiments, the support elements, for example SMP poles or tubes are produced in the basic shapes “C”, “U”, “U (overstretched)” or “V” (see FIG. 1, top row). The C-shape resembles the classic shape of a round arch, and the U-shape resembles the shape of the gable of a foil greenhouse. This illustration of shapes is by no means complete. In order to be able to ensure adequate anchoring in the ground subsequently, SMP poles/tubes with angled ends can also be used (see FIG. 1, bottom row).

One or more support elements are fastened in the temporary, straight/stretched form thereof to one side of the sheet material, for example a foil. According to one or more preferred embodiments, the sheet material (such as the foil) is laid out or spread out with the support elements attached to one side thereof in such manner that the support elements are covered with the sheet material (for example the foil).

According to one embodiment, the air under the foil and the SMP of the support element is warmed over a certain period of time under the effect of solar radiation and the outside temperature. This warming triggers the known shape memory effect (SME) for the shape memory polymer of the support elements. Consequently, the support elements self-erect or the apparatus, for example a polytunnel, unfolds automatically.

According to another embodiment, the shape memory effect of the SMP is triggered by an externally controlled and thus predefined and metered application of heat to the support elements at the desired time. This causes self-erection of the support elements or unfolding of the apparatus, for example a polytunnel.

In the following, two types of guide bearings for the support element are described. Type 1 comprises a groove, type 2 comprises a ridge or convexity. The term “groove” is understood to mean an elongated surface depression that extends from one end of the pole/tube to the other. The term “ridge” is understood to mean a corresponding elongated convexity, which may be interrupted intermittently at regular or irregular intervals. The groove and ridge serve as guide bearings in the subsequent insertion of the pole/tube made from SMP in a foil pouch as described below. The groove and the ridge allow only one orientation of the SMP support element in the foil pouch. The interchangeability of the terms “groove” and “ridge” applies to all options for shaping the cross section and surface structure of SMP poles/tubes described in the following.

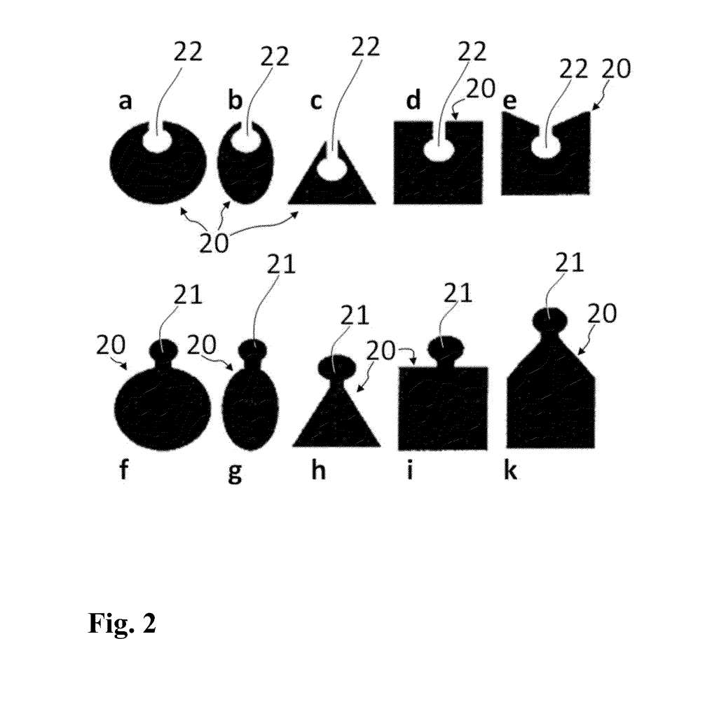

FIG. 2 shows cross-sectional shapes of SMP poles (20). The pole cross-section is typically circular (see FIGS. 2a, 2f). In addition, if the pole (20) has a prism-shaped geometry, the geometrical shape of its cross section may be oval (FIGS. 2b, 2g), triangular (FIGS. 2c, 2h), rectangular (including the shapes: square, rhombus, rectangle, kite quadrilateral, parallelogram, trapezoid, tangent quadrilateral, cyclic quadrilateral, convex and concave quadrilateral and concave kite quadrilateral; see FIGS. 2d, 2i) or pentagonal (FIGS. 2e, 2k). The cross-section may also have the form of geometric objects with more than 5 corners. The cross-section may also have a five-pointed (pentagram) or six-pointed (hexagram) star geometry. Each corner of the geometric figures in FIG. 2 may also be rounded.

The cross-sectional shapes of SMP poles (20) corresponding to the basic shapes of circle (a), ellipse (b), triangle (c), square/rectangle (d) and pentagon (e) are illustrated for exemplary purposes in FIG. 2. FIGS. 2a to 2e as shown in the upper row have a groove (22), FIGS. 2f to 2k have a ridge (21). A separate ridge is not necessary for the triangular (FIG. 2h) and pentagonal (FIG. 2k) shapes (this does not apply if the triangle is an equilateral triangle).

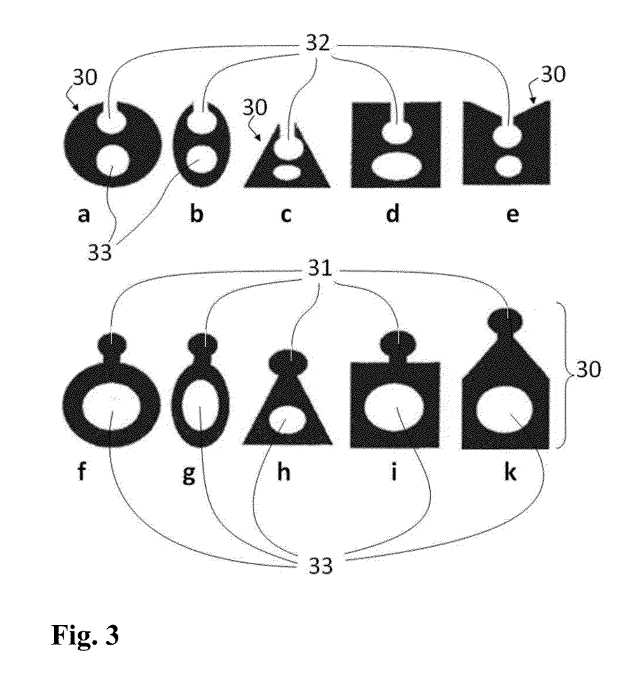

Tubes (30) made from SMP may also be used instead of poles (20). A selection of possible cross-sectional shapes for SMP tubes (30) is shown in FIG. 3. Here too, the support elements have a ridge (31) or groove (32) at least in sections.

The shapes described for the ridge (21, 31) and the groove (22, 32) are represented as round in the examples. According to other embodiments, the cross-sections of the grooves (22, 32) and ridges (21, 31) may also be square or polygonal surfaces.

FIG. 3 shows cross-sectional shapes of SMP tubes (30) similar to the basic shapes a to k shown in FIG. 2. The diameters of openings (33) are freely selectable. In addition, tubes (30) may be shaped so that they include more than one void in cross section. According to one or more embodiments, a pole/tube (30) is traversed as it were by a plurality of closed air chambers or continuous channels that are open at each end. All geometric objects shown in the figures and described herein may be realised either with or without guide bearings (groove/ridge). The guide bearings may be structured as shown in the figures, for example. Any other options for structuring the guide bearings may also be chosen.

For example, round shapes may be replaced with square forms. Compared with poles, tubes generally have the advantage that they enable the SMP to be triggered faster if heating is preferably carried out from the inside and optionally from the outside at the same time as well. According to a preferred embodiment, the support element is heated to a temperature above the switching temperature of the shape memory polymer. The ends of SMP tubes may be fitted with suitable connectors, for example a fluidic connector, an adapter such as a threaded element, or other connectors. According to a preferred embodiment, at least one support element includes a channel, the respective ends of which open into a connector that is suitable for a hose connection, a plug-in, threaded, retaining, detent, clamping or compression connection. One advantage of this embodiment is that the channels extending in the interior of multiple support elements may be interconnected by hoses for example. A preheated and/or appropriately temperature controlled fluid may thus be able to flow through the closed channel formed in this way at a desired time.

According to one exemplary embodiment, at least one channel or void (33) in the support element may be filled with a heat storage medium. Channels and voids in the support element may also be filled with an electrically conductive material having a certain ohmic resistance that heats up when current flows, and transfers heat to the surrounding SMP.

If this type of resistance heating is used, each end of the continuous channel (33) comprises a connector, which ensures reliable contact with a power source. The connector is designed in such manner that electrical insulation from the environment is guaranteed, even in conditions of condensation, precipitation, additional irrigation or spraying.

Adapters or connectors may also be attached to the openings of otherwise closed foil pouches. The advantage of such connecting elements is that the foil pouch can be used as a sheath for the support element that comprises SMP. A foil pouch furnished with adapter fittings or connecting elements may be used for setting up the polytunnel in that a suitably temperature controlled fluid flowing through the foil pouch causes the support element inside the pouch to recover its original, curved shape.

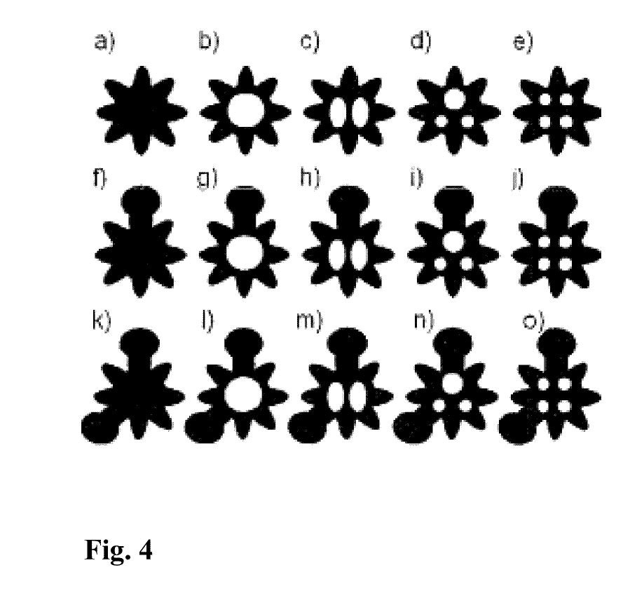

According to other embodiments, the surface or cross-section of the support elements, that is to say the poles/tubes made from SMP, is designed to have a large external surface area. This offers the advantage of improved temperature control capabilities. This in turn has a positive effect on the speed of shape restoration (recovery) of shape memory polymers from a temporary shape to the permanent shape, for example. One possible cross-sectional structure resembles a fan rosette (see FIG. 4). FIG. 4 shows cross-sectional shapes of SMP poles/tubes. Without an air chamber (a), with one air chamber (b, g), with two air chambers (c, h) with three air chambers (d, i), and with four air chambers (e, j). The cross sections of FIGS. 4f to j each have one guide bearing, those in FIGS. 4k to o each have two.

If required, closed voids, for example air chambers (FIGS. 4b to e) may also be used effectively here. A guide ridge (FIGS. 4f to j) may also be integrated. The number of protrusions in the cross-sectional geometry of the fan rosette type may be from 3 to any number, in particular from 3 to 20. The number of air chambers may be from none to 2000, in particular from 1 to 12. The number of guide bearings or ridges may also be varied, increased to two for example (see FIGS. 4k to o).

According to a particularly preferred embodiment, at least areas of the at least one support element has/have a cross section with an indented contour and/or indented surface, enabling heat to be exchanged with the surrounding atmosphere more efficiently. At least areas of a support element may also have one or more protrusions or elevations arranged one behind the other in the lengthwise direction thereof. Corresponding recesses, depressions or channels may be conformed substantially diametrically opposite said protrusions or elevations arranged successively along the length of the support element.

The advantage of this is that multiple support elements can be connected to each other lengthwise. This in turn facilitates thermal programming of a plurality of support elements providing they are not yet attached to the sheet material/foil. In addition, multiple support elements that are already suitably attached to the sheet material/foil may be attached to each other longitudinally, thus enabling a further form of the space-saving folding of the polytunnel in addition to the rolled up or undeployed form of the polytunnel with straight/extended support elements with the SMP in the temporary shape, which will be explained in the following.

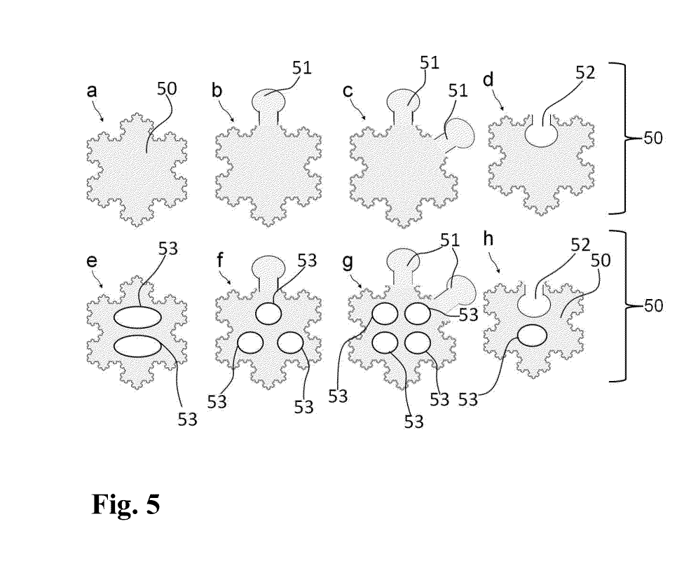

In order to improve heat exchange, but also to assist with mechanical stability, the outer contour of the support element cross section may resemble a fractal structure or similar. In this way, an advantageously large surface area of the cross section of the support elements is created, ensuring improved heat exchange with the ambient air, for example. Examples of advantageous geometries are cross-sectional geometries in the style of the Koch snowflake (FIG. 5a). Here too, it is recommended to furnish at least portions of the support element surface with an additional ridge 51 (see FIGS. 5b and f) or two ridges 51 (FIGS. 5c and g), a groove 52 (FIGS. 5d and h) and air chambers 53 (FIGS. 5e to h) or channels 53. In the same way, the cross section of the pole/tube may resemble the cross-section of a Menger sponge.

After preparation, the SMP or support element has assumed its permanent shape. In the following, a number of concepts for fixing the support elements are presented, for example poles/tubes made of SMP in the temporary shape thereof.

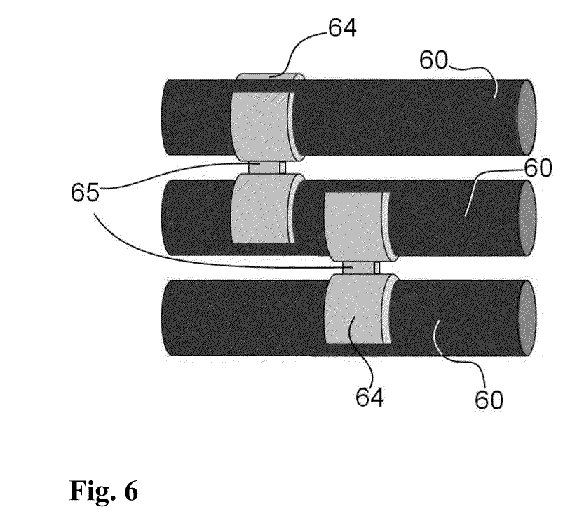

Concept 1: The “folding doors” concept has proven to be particularly useful. The individual SMP poles/tubes are interconnected in such a way that they can be stacked one on top of the other. Adjacent SMP poles/tubes (60) may be connected with the aid of spacers (64, 65) for example (see FIG. 6). FIG. 6 shows spacers (64, 65) as connecting elements for support elements (60) in the form of poles or tubes made from SMP.

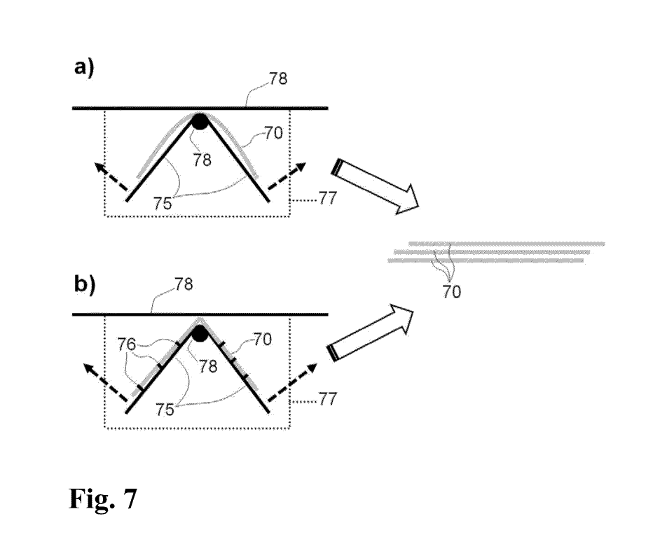

It is also possible to insert the individual support elements or poles/tubes (60) made from SMP directly in clamping devices (76) that are attached to a door (75) (FIG. 7). In this case, it has proven helpful to use the groove and ridge in the SMP poles/tubes, or fastening clips (64). In the next step, the SMP is heated to a temperature T, wherein T>Tₜᵣₐₙₛ and generates a force across two folding doors (75) with which the SMP poles/tubes are pressed against a wall (78) located behind the folding door (see FIG. 7). This deformation preferably takes place in a heated area (77), which is generated for example by a hot air stream or similar.

A preferred method for heat-induced deformation of at least one support element of the described apparatus from a first shape thereof, corresponding to the permanent configuration of the shape memory polymer, into the second shape thereof, corresponding to the temporary configuration of the shape-memory polymer or vice versa—from the second to the first shape thereof—comprises the following steps:
(a) placing a plurality of support elements (20, 30, 50, 60, 70, 80, 100) one on top of the other and/or side by side as a layer or stack or as a layer stack of detachably interconnected support elements (having a given shape on a first area, wherein the first area has at least two subareas that are pivotable relative to one another, and the middle surface normals of which together form a first angle or extend parallel to one another;
(b) raising the temperature of the shape memory polymer above the glass transition temperature or the softening temperature thereof, either indirectly by heating at least one of the subareas, or by heating the plurality of support elements (20, 30, 50, 60, 70, 80, 100) directly;
(c) pivoting at least one of the two subareas relative to the other subarea such that, unlike before, the middle surface normals of the subareas now extend parallel to one another or form a second angle together that differs from that of the preceding step (a);
(d) lowering the temperature of the shape memory polymer to below the glass transition temperature or softening temperature thereof, either indirectly by cooling at least one of the subareas or by bringing the plurality of support elements into contact with a coolant, or a cool or cooled second surface or wall (78);
(e) removing the reshaped support elements (20, 30, 50, 60, 70, 80, 100) from the layer or stack.

FIG. 7 illustrates the folding doors concept for transforming the SMP poles/tubes 70 into their temporary shape (“thermal programming”). The “folding door” is formed by two panels 75 that are pivotable relative to one another by means of a hinge or bearing (78). The concept shown is in a C-shape as an exemplary representation of a stack of multiple support elements, for example SMP poles/tubes (see plan view a in FIG. 7). Similarly, folding doors with clamping devices (76) mounted thereon may be used for purposes of programming the shape of the SMP (see plan view b in FIG. 7).

In their new, closed form, the folding doors are adjusted and the ambient temperature is lowered to the shape fixing temperature of the shape memory polymer. This may optionally be carried out gradually, overnight for example. Once the SMP poles/tubes are fixed in their new, straight shape, the folding doors can be opened and spacers (65) between the SMP poles/tubes can be detached and taken out of the clamping devices (76) in the folding door.

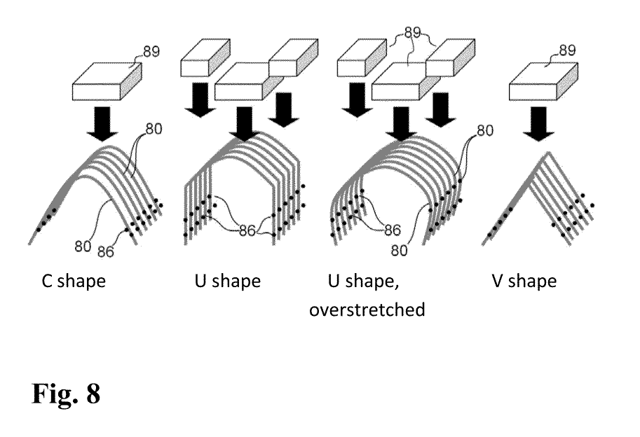

Concept 2: In order to transform the C-, U-, overstretched U- or V-shaped SMP poles/tubes into a straight shape, the support elements are connected to each other lengthwise, as shown in FIG. 6, for example. The SMP is then heated to a temperature T, wherein T>Tₜᵣₐₙₛ and subjected to a load (FIG. 8), this load being maintained until the SMP poles/tubes have been fixed in the new, straight shape by cooling to below the shape fixing temperature (glass transition or soft segment crystallization temperature) of the shape memory polymer.

FIG. 8 shows the shape fixing under load for transforming the SMP poles/tubes (80) into the straight (temporary) shape. Connecting elements (86) for adjacent SMP poles/tubes are indicated with black dots. The source of the load may be for example one or more sufficiently large and heavy plates (89), made of metal, for example. It has proven to be particularly effective if the load is allowed to act on the SMP poles/tubes for an extended period (several hours). If this is carried out outdoors, colder overnight temperatures may be used to advantage to fix the temporary shape permanently. The SMP remains in the new, temporary shape until the shape memory effect is triggered by heating the shape memory polymer to T>Tₜᵣₐₙₛ.

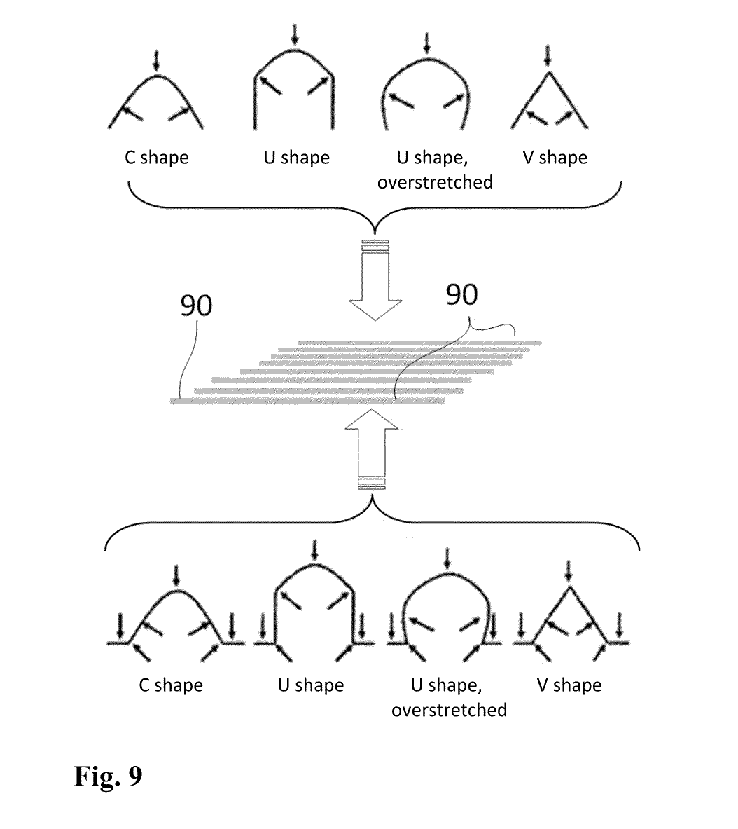

Regardless of which of the described concepts is chosen for shape fixing, FIG. 9 shows the points on the SMP poles/tubes where forces may be applied to best effect to change the shape thereof. The diagrammatically shown load on the support elements in their permanent form (C-shape, U-shape, overstretched U-shape, V-shape) results in the shape of the poles/tubes being changed to a straight shape (see FIG. 9, 90) regardless of whether angled end pieces are present (see FIG. 9, bottom row). The fixing of the SMP shape in the temporary configuration thereof as described here is also referred to as “programming” or the “programming step”.

FIG. 9 illustrates the deliberate use of forces to shape poles/tubes made from SMP that are in the shape of a C, a U (optionally an overstretched U shape) or a V. Arrows are placed to show the points at which forces may be applied to bring about the deformation. As a result of the programming, a straight pole/straight tube (90) of SMP (shown at centre) is obtained.

When programming, it is important to ensure that any existing groove, ridge or series of guide bearings is not deformed, otherwise the SMP poles cannot be introduced into the foil pouches as required. In such cases, if possible the force should not be applied directly to a groove or ridge. Therefore, the structural shape of a ridge may be interrupted at certain points where forces are applied for programming (see arrows in FIG. 9).

As an alternative to the programming according to concepts 1 and 2, the shape memory polymer may be deformed at T<Tₜᵣₐₙₛ (where applicable at 23° C.). To ensure good fixing of the temporary shape of the support element, in other words a pole or tube made from SMP, the ambient temperature is cooled to a temperature below the shape fixing temperature after deformation has taken place. Also in this case, the cooling is mainly responsible for the fixing and freezing of the tension applied during the deformation. Finally, the SMP is heated to the ambient temperature (T<Tₜᵣₐₙₛ). It is then kept in the new, temporary shape until the shape memory effect is triggered.

In the case of shape memory polymers with inadequate shape memory properties in the first thermomechanical cycle (including programming and shape recovery), the one-time triggering of the shape memory effect and re-programming of the shape memory polymer can result in significant improvement of shape memory properties. In cases where the shape memory properties still vary even after the second cycle, it is still useful to subject the object to repeated thermomechanical cycles. In the course of optimising material functionality, the permanent shape can be preselected in such manner that deviations from the ideal shapes, C, U, overstretched U, V, can be introduced deliberately to obtain a desired permanent shape after shape recovery in the future.

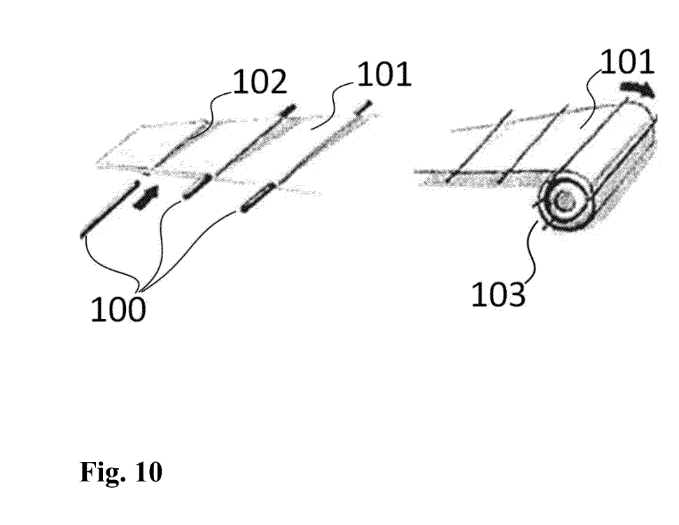

Preparation, transport and assembly of a functional polytunnel: After the programming of the shape memory polymer is completed, the straight poles/tubes 100 are inserted in foil pouches 102 of the plastic foil 101 arranged at equal distances from each other. Foil 101 with poles/tubes 100 inserted can then be rolled up into a roll 103 as shown on the right in FIG. 10.

The plastic foil is a standard commercial material. For example, a mesh foil, bubble wrap, heat foil, freezing protection foil, insulating foil, blister padding, hothouse anti-dew foil, garden foil, greenhouse foil, perforated foil, slitted foil, tubular foil or air cushion foil may be used. For the sake of simplicity, it will be referred to consistently in the following as “plastic foil”.

It should be ensured that the geometry of the foil pouches is adapted to the cross section of the pole or tube. Strictly speaking, this means that one or more guide rails or jigs can be incorporated for this purpose, or the plastic foil pouches may be created with the corresponding shape from the outset. This ensures that the correct, direction-controlled erection of the entire construction can take place counter to the selected programming direction when the shape memory effect is triggered later.

In order to enable correct functioning, markings are applied after the SMP programming—in particular close to the ends of the tubes and poles—to show how far the SMP poles/tubes are to be inserted into the foil pouches provided (see FIG. 10, left).

FIG. 10 illustrates the insertion of the straight (pre-programmed) SMP poles/tubes 100 into pouches 102 of a plastic foil (left), after which the entire structure is rolled up (right). The entire structure can be transported in a rolled-up state to the intended usage site. With regard to storage and transport of SMP-based polytunnels, it must be ensured that poles/tubes made from SMP must be shipped and stored at temperatures below the switching temperature and above the shape fixing temperature.

In addition, suitable packaging must be used to ensure that the SMP poles/tubes are kept in a dry environment, otherwise there is a risk that the SME may be partially triggered due to water absorption (“plasticizing effect”) or that the material may be reprogrammed.

Accordingly, a method for producing a device of the type described, comprises, for example, the following steps:
(a) providing a sheet material,
(b) attaching at least one support element to the sheet material, wherein the support element comprises at least one shape memory polymer and has a substantially straight shape, and/or is present in a temporary configuration of the at least one shape memory polymer;
(c) rolling or folding up the sheet material that is furnished with the at least one support element.

The rolled, undeployed form of the devices described, provides the advantage of space-saving storage and easier transport, for example.

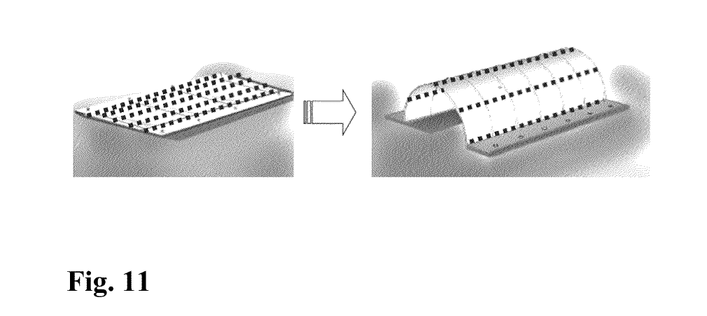

On site, the construction is laid out as shown in FIG. 11. It is advisable to erect the polytunnel on a warmer day, when temperatures are only slightly below the Tₜᵣₐₙₛ of the shape memory polymer, because then only a relatively small amount of heat needs to be supplied by the user to trigger the shape memory effect.

FIG. 11 shows a plastic sheet with programmed SMP poles/tubes before (left) and after (right) the shape memory effect is triggered. Cross braces to increase overall stability are indicated by the dotted lines in the figures on the left and right.

Once the structure has been spread out fully on the ground, if necessary polymer or metal connecting poles/tubes may be used as cross braces for the SMP poles/tubes, as indicated by the dashed lines in FIG. 11. Besides the connection of the centre points of the SMP poles/tubes (dotted line at the apex of the arches in FIG. 11, right) any number of cross braces may also be inserted in the peripheral regions of the plastic foil and/or between said regions (dotted lines to the left and right of the apex in FIG. 11). All of these connecting poles or tubes combine to lend a greater degree of stability to the overall structure.

In this context, the polymer or metal connecting poles/tubes can always span at least one or more spaces between the SMP poles/tubes. They can be connected directly to the SMP poles/tubes, providing the SMP poles/tubes comprise correspondingly sized apertures into which the ends of the polymer or metal connecting poles/tubes can be inserted.

Plastic foil 101 may also be designed such that adjacent foil pouches 102 are connected to one other, thus making it easier to control temperature later, with hot water for example.

If the longer SMP poles/tubes with angled ends in the permanent shape shown at the bottom of FIG. 1 are used, these angled ends can be embedded in the ground after the shape memory effect is triggered.

The shape memory effect is triggered by heating the shape memory polymer to above Tₜᵣₐₙₛ. This can be done in a number of ways. The SMP can be heated using an infrared heat lamp, a radiant heater with hot water at a temperature T (T>Tₜᵣₐₙₛ), with a hot air blower, and on very warm days even directly through interaction with sufficiently warm ambient air. In very warm geographical regions the SME is induced directly by direct sunlight, the surrounding atmosphere and the radiation of heat from the ground.

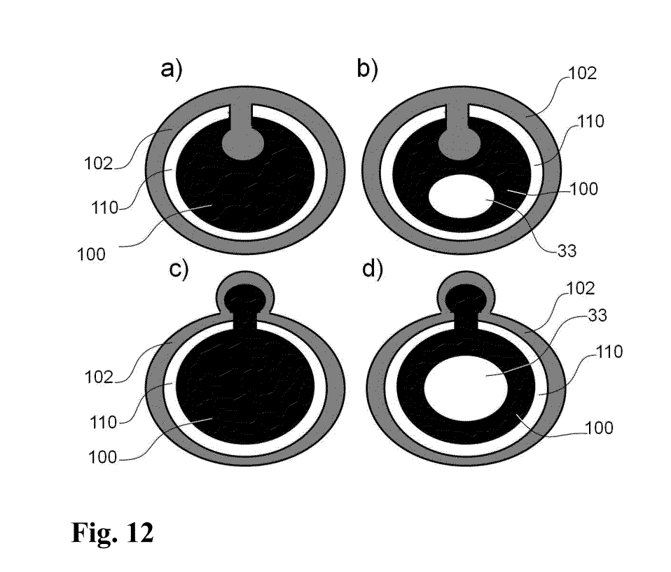

If a liquid (for example water) is used for temperature control of the SMP tubes, the tube ends are connected directly to hoses that are in turn connected to a temperature controlled liquid reservoir (this is not shown in FIG. 12, however). Foil pouches 102 may also be connected to hoses directly to control the temperature of the SMP poles/tubes arranged in the foil pouches (FIG. 12). A circulating pump ensures that the temperature-controlled fluid flows through channels 33, and by controlling the temperature of the SMP poles/tubes causes them to regain their former shape and the polytunnel to be erected. Additionally, if the foil pouches and the ends thereof are designed suitably, a temperature-controlled fluid may also flow through the voids 110 between pole/tube 100 and the foil of foil pouch 102.

The use of self-erecting columns and support arches results in significant simplification of the assembly and erection of polytunnels, since intervention by an operator is essentially limited to rolling or spreading out the foils equipped with the support elements, and where applicable connecting the connectors and hoses to the adapter elements provided. This reduces the time and cost required for assembly.

Advantages may also be derived from the fact that cultivation areas for which polytunnels are provided are initially only covered with a protective foil sheet until the amount of heat applied causes the respective crop to rise or reach a certain state. Then, when sufficient heat has accumulated during the day then causes the support elements to rise automatically and the polytunnel to self-erect.

The point in time at which the device is erected automatically, induced solely by solar radiation for example, may be determined through appropriate configuration of the support elements and the properties of the SMP, by defining the minimum quantity of heat required to trigger the SME from the quantity of heat that is absorbable during the day under the given conditions. Alternatively, it is possible to select a time when the polytunnel self-erects by passing a suitably heated fluid through one or more support elements, or activating a resistance heater that is disposed in the interior of the poles/tubes. These last methods for erecting a polytunnel offer a particular advantage in that, if at least sections of the channels of adjacent support elements are interconnected, or if individual support elements or a plurality of adjacent support elements are connected, a polytunnel can be erected only partly or in stages depending on the respective requirement.

FIG. 12 shows an exemplary schematic diagram of the cross section of a pole 100 (in diagrams a and c) or a tube 100 (in diagrams b and d) made from SMP, and each having a guide bearing (groove: diagrams a and b, and ridge: diagrams c and d) that is located in a foil pouch 102. The temperature of the support element can be controlled, and the support element can be converted to its permanent shape using warm water that flows through channels 33 and the voids 110 between foil pouch 102 and pole/tube 100.

The temperature of the shape memory polymer can be controlled significantly more quickly in SMP tubes than in SMP poles, since in this case the temperature control can be carried out from both the “exterior” and the “interior”.

If shape memory polymers are equipped with electroactive or magnetosensitive filler materials, the alternative possibility of indirect heating with an external magnetic or electrical field is created. In addition, the thermal conductivity of the shape memory polymer may be increased by different filler materials. A selection of such materials will be listed by name later in the description.

The triggering of the shape memory effect causes the deformation of the support elements, that is the SMP poles/tubes, such that they develop a force orthogonal to the ground (counter to the direction of deformation). In this process, the SMP poles/tubes return to their original (that is to say permanent) shape. This causes the SMP poles/tubes to self-erect, taking the plastic foil with them. The opposing contact surfaces with the ground are drawn toward each other. Consequently, when the shape memory transition is complete the central portions of the poles/tubes are at the highest distance above the ground. If a liquid is used to control the temperature, when the self-erecting structure is fully raised, the water is drained out of the SMP foil pouches/tubes.

After the material has been heated above Tₜᵣₐₙₛ for the SMP, the contact surfaces are anchored in the ground. Standard, commercially available fastening equipment is used for this, conventional ground anchors for example. As indicated in FIG. 11 (right), it is also possible to use heavy plates such as stone slabs or the tubes for filling the support elements with a heated fluid to weight the overall construction. If this leads to cold deformation effects at the ends of the SMP poles/tubes, these can easily be reversed later by local heating.

The following is a description of an alternative to the construction explained in the preceding. The quantity of heat required to trigger the shape memory effect can be reduced to a minimum if the “accordion” operating procedure is applied:

1. The programmed SMP poles/tubes are introduced into the plastic foil as described. All SMP poles/tubes are lying as close to each other as possible. The SME is triggered before the overall construction design has been fully spread out.
2. The SMP poles/tubes are set up at the intended spatial intervals relative to each other and at the same time the plastic foil is spread out over the area to be protected. Visual comparison of adjacent SMP poles/tubes makes it possible to determine early whether the recovery deformations to the permanent shape have been fully completed.

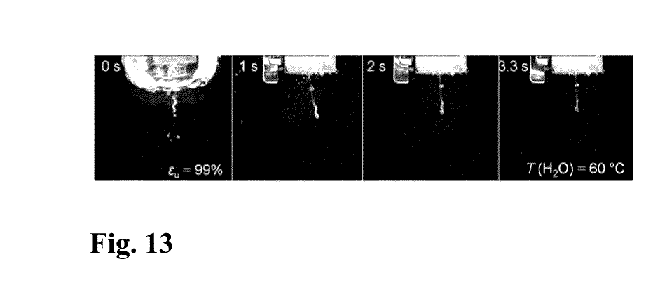

Details of the recovery deformation speed of a shape memory polymer when the shape memory effect is triggered: according to one embodiment for determining the recovery speed of an adipate-based shape memory polymer manufactured by Bayer MaterialScience AG in hot water, it was found that with a water temperature of 60° C. shape recovery of a tension bar stretched by εₘ=100% was completed within 3.3 seconds. This is shown in FIG. 13. The image sequence in FIG. 13 shows the strain recovery of a tension bar made from adipate-based SMP triggered in water at a temperature of 60° C.

Combination with commercially available additions and instructions for use: After they have been erected, the polytunnels can be equipped with additional devices for ventilation, lighting and irrigation. Solar fans can also be used. However, it must be ensured that the SMP supporting poles/tubes are not overloaded. Use in conjunction with heat accumulators for uniform temperature control of the polytunnel is possible as long this does not cause the switching temperature of the shape memory polymer to be exceeded, otherwise there is a risk that the SMP poles/tube may become mechanically unstable. Therefore, it is not recommended to heat constructions made from self-erecting, SMP-based structures to temperatures above the switching temperature for prolonged periods.

According to one embodiment, the selected plastic foils may be structured such that ventilation flaps or windows (skylights for example) or doors are already integrated therein, for example by the presence of zip fasteners. The structuring possibilities are exceedingly diverse. It is even possible to install struts for attaching tomato stakes or for attaching twine for growing climbing plants or cucumbers.

According to another embodiment, a polytunnel may be designed with fleeces (mulch fleece, spun fibre fleeces, gardener's fleeces, early harvest fleeces) and base fabrics for weed protection, weed prevention, insect repellent, frost protection, early harvesting, etc., on the bottom thereof, which is ideally installed before the erection shown in FIG. 11.

Deconstruction of the polytunnel: In order to deconstruct a polytunnel that is erected and anchored in the ground, first the additional devices listed above and the fastening elements are taken out of the ground, and where applicable the weighting elements at the peripheral areas are removed. Then the cross braces are disassembled, the plastic foil is cut open and the SMP poles are taken out and collected together. The SMP poles/tubes are connected to each other with suitable connectors just above the ground in such manner that their distance from each other is kept constant in accordance with crosspiece length 65 of spacer 64 (FIG. 6). Now, the “folding door” concept described previously can be applied (FIG. 7a). It is also possible to dispense with the interconnection of the SMP poles/tubes and to attach them in the folding doors 75 directly using clamping devices 76 or other means (FIG. 7b). As an alternative to the folding door concept, the recovery of the temporary shape of the SMP poles/tubes may be facilitated by applying a weight. Then, when the SMP poles/tubes are in a substantially stretched state, they can be inserted in a new plastic foil.

Technical details: The total length of a polytunnel may be from 50 cm to several 100 m, particularly between 5 and 100 m. The outer diameter of the SMP poles/tubes is between 0.5 mm and 300 mm, particularly between 10 mm and 100 mm. The choice of a sufficiently large diameter ensures that the overall construction, consisting of plastic foil and poles/tubes, can be erected and also that the SMP poles/tubes are capable of reliably supporting the weight of the plastic foil even at temperatures above Tₜᵣₐₙₛ of the shape memory polymer. The SMP poles/tubes may be arranged equidistantly from each other. In such cases it is advisable to select distances in the range from 0.1 m to 10 m, particularly between 0.5 m and 3 m. The thickness of the plastic foil is between 0.01 mm and 20 mm, particularly between 0.05 mm and 3 mm. The switching temperature of the shape memory polymer to be used is ideally between 30° C. and 50° C., the shape fixing temperature is ideally below 23° C. The shape of the foil pouches is an almost identical fit with the cross section of the SMP poles/tubes used. The plastic foil used is thermally stable at temperatures that occur during both the construction and deconstruction of a polytunnel due to heating of the SMP poles/tubes to temperatures T>Tₜᵣₐₙₛ (SMP). The length of the crosspiece 65 in spacers 64 between the SMP poles/tubes (FIG. 6) is 1 mm to 500 mm, preferably from 20 mm to 100 mm.

Advantages of a functional polytunnel: The following section briefly lists some examples of the particular advantages of the self-erecting device described using the example of a polytunnel:
The polytunnel can be transported without undue effort.
There is a significant gain in functionality compared with polytunnels such as a Filclair Tunnel for example. Since the SMP can be integrated in the plastic foil, the complicated task of pulling the plastic foil over the arches afterwards can be dispensed with. Installation can also be “invoked” sequentially via the applied stimulus, and is thus easier to control.
The polytunnel is significantly lighter than conventional constructions, in which metal poles are being used more frequently. Thus it is also comparatively easier to carry out a change of location.
Unlike fixed location greenhouses, the polytunnels are licence-exempt plant-protection shelters without steel and concrete foundations and do not require building approval from the construction authorities in Germany.
The shape memory polymers that may be considered for use are plastics that have a “self-healing” effect: in the event of deformations caused by inclement weather, the permanent shape can be restored easily. This is done by reheating misshapen SMP poles/tubes to above the switching temperature of the shape memory polymer.
Polytunnels and appropriately sized variants thereof (self-erecting structures) can be used for a wide variety of applications.
Other possible applications are made possible with the use of textiles, nonwovens, paper, polymer network, wire mesh, gauze or a combination of a foil with similar or other sheet materials.

A self-erecting device of the type described can be used as more than just a shelter or polytunnel in the cultivation of ornamental or crop plants in the small garden and hobby sector as well as in agriculture and forestry. Other fields of use for the device described relate mostly to temporary or seasonal shelters, protection and stretch walls and shelters, carports, boat canopies, swimming pool covers or shelters, pool enclosures, emergency accommodation, emergency garages, covers or other components of market stalls, awnings and sunscreens, shade cloth, hail protection netting, bird protection netting, starling protection, tents (including tents for camping, marquees and others), gazebos, tool sheds, storage space, canopies for aviary or small animal runs (e.g., rabbit and hare hutches, outdoor areas for tortoise cages, birdhouses, and so forth), pond shelters, compost bins, fences, snow fences or use as snow catcher—for example, on pitched roofs, and/or as an advertising medium for visual advertising, especially for outdoor advertising.

Shape memory polymers: Currently, most of the shape memory polymers described in the literature have a thermally-induced shape memory effect. This means that when programmed polymer materials are heated above a defined transition temperature, a shape recovery process takes place, caused by entropic elasticity. Shape memory polymers are usually polymers in which chemical (covalent) or physical (non-covalent) cross-linking sites define the permanent shape. Examples of such switchable polymers are phase-segregated linear block copolymers consisting of hard and soft segments.

According to one embodiment, the SMP may be a thermoplastic shape memory polymer, particularly from the group of linear block copolymers, in particular polyurethanes and polyurethanes having ionic or mesogenic components, block copolymers of polyethylene terephthalate and polyethylene oxide, block copolymers of polystyrene and poly(1,4-butadiene), ABA triblock copolymers of poly(2-methyl-2-oxazoline) (A-block) and polytetrahydrofuran (B-block), multiblock copolymers consisting of polyurethanes with poly(ε-caprolactone) switching segment, block copolymers of polyethylene terephthalate and polyethylene oxide, block copolymers of polystyrene and poly(1,4-butadiene), polyurethane systems, the hard segment forming phase thereof consisting of methylene diphenyl diisocyanate (MDI) or toluene-2,4-diisocyanate and a diol, particularly 1,4-butanediol, or a diamine and a switching segment based on an oligoether, particularly polytetrahydrofuran, or on an oligoester, particularly polyethylene adipate, polypropylene adipate, polybutylene adipate, polypentylene adipate or polyhexylene adipate, materials having a hard segment-forming phase of toluene-2,4-diisocyanate, MDI, diisocyanates that are particularly constructed from MDI or hexamethylene diisocyanate in carbodiimide-modified form and chain extenders, particularly ethylene glycol, bis(2-hydroxyethyl)hydroquinone or a combination of 2,2-bis(4-hydroxyphenyl)propane and ethylene oxide, switching segment determining blocks thereof consisting of oligoethers, particularly polyethylene oxide, polypropylene oxide, polytetrahydrofuran or a combination of 2,2-bis(4-hydroxyphenyl)propane and propylene oxide, or of oligoesters, particularly polybutylene adipate, materials of polynorbornene, natural rubber (cis-1,4-polyisoprene), trans-1,4-polyisoprene, graft copolymers of polyethylene/nylon-5, block copolymers with polyhedral oligomeric silsesquioxanes (POSS), including the combinations polyurethane/POSS, epoxy/POSS, polysiloxane/POSS, polymethyl methacrylate/POSS, silicone-based shape memory materials polymers and materials consisting of poly(cyclooctene).

In poly(ester urethanes), switch segment blocks may be formed from poly(ε-caprolactone) diols with molecular weight number averages between 1500 and 8000 among others. The switching temperature for the shape memory effect may vary between 44 and 55° C. depending on the weight fraction of the switching segment (variation between 50 and 90% by weight) and the molecular weight of the poly(ε-caprolactone)diols. The crystallization temperatures are between 25° C. and 30° C. Block copolymers consisting of trans-polyisoprene and urethanes exhibit the SME, the recovery temperature is 65° C., the crystallization temperature depends on the chemical composition and can be adjusted between 0° C. and 30° C. The shape memory properties of trans-polyisoprene (including the recovery rate and recovery temperature) may be altered by using carbon black as a filler or auxiliary material.

According to another embodiment, polyadipate-based poly(ester urethanes) are suitable for the application described here because the switching temperature of the soft segments thereof is about 37° C. and the crystallization temperature is well below 23° C. (≦10° C.). Moreover, the material possesses adequate shape-memory properties (shape recovery capability, fixability) and has long-term stability. The described poly(ester urethane) was found to be readily processable. It was further found that approximately 75% of the tension applied for stretching is made available again for shape recovery (during triggering of the shape memory effect).

According to another embodiment, the SMP may be an elastomeric SMP, particularly from the group of polyvinyl chloride, polyethylene-polyvinyl acetate copolymers, covalently crosslinked copolymer systems of stearyl acrylate, and esters of methacrylic acid.

Conventional materials that are used in the field of polytunnels may also serve for the described application provided they have adequate shape memory properties. Suitable materials include all block copolymers that ideally have a melting temperature above 30° C. and a crystallization temperature below 23° C. To these may be added the materials having a glass transition temperature in the range between 30 and 100° C., particularly between 40 and 60° C.

According to advantageous embodiments, the SMP may have the form of a shape memory polymer composite. In this context it should be noted that the terms shape memory polymer and shape memory polymer composite are used interchangeably in this document. In other words, a correspondingly suitable SMP composite may also be used instead of a shape memory polymer or vice versa. SMP composites are understood to be materials in which one or more fillers is/are embedded in the SMP matrix.

Suitable fillers may be for example magnetic nanoparticles, ferromagnetic particles, particularly NiZn particles, iron oxide particles and magnetite particles. Nanoclays may also be used as fillers. The nanoclays may be created on a basis of silicon nitride, silicon carbide, silicon oxide, zirconium oxide and/or aluminium oxide for example.

Other possible fillers are oligomeric silsesquioxanes, graphite particles, graphenes, carbon nanotubes, synthetic fibres, particularly carbon fibres, glass fibres or Kevlar fibres, but also metal particles. Of course, combinations of said fillers may also be used. The fillers are suitable for adjusting the mechanical, electrical, magnetic and/or optical properties of a shape memory polymer and adapting it to the respective application.

Besides the thermosensitive SMP materials described, magnetosensitive or electroactive materials also lend themselves to the intended use described here of an SMP in support elements for polytunnels or similar devices. Magnetically controlled shape memory polymers can be prepared by incorporating finely distributed magnetic nanoparticles, for example from iron oxide, in the plastic. Such materials are then capable of converting the energy of a magnetic field into heat, so that the SME is triggered in programmed shape memory polymers. A desired temperature may be set precisely in the polymer via the proportion of nanoparticles and the strength of the magnetic field. Shape memory polymer composites with carbon nanotubes for example may be used as electroactive polymers (EAP). Thus, there are various ways to trigger the SME.

The present invention has been explained with reference to certain embodiments. These embodiments should not be construed as limiting of the present invention in any way.

The following claims represent a preliminary, non-binding attempt to define the invention in general.

What is claimed is:

1-13. (canceled)

14. A device comprising:
a sheet material; and
at least one support element that is connected to the sheet material, wherein the at least one support element comprises at least one shape memory polymer in such a manner that the device has a substantially flat shape in a first configuration of the at least one shape memory polymer, and
has a substantially curved shape in a second configuration of the shape memory polymer.

15. The device of claim 14, wherein
the first configuration can be converted to the second configuration by heating.

16. The device of claim 14, wherein
the at least one support element comprises a channel, the respective ends of which open into a connector that is suitable for a hose, plug, threaded, retaining, detent, clamping or compression connection.

17. The device of claim 14, wherein
the second configuration of the shape memory polymer is induced by heating a temperature controlled fluid located in the channel, or by a heated electrically conductive material in the channel.

18. The device of claim 14, wherein
the at least one support element comprises closed voids.

19. The device of claim 14, wherein
the at least one support element has a cross section with an indented contour or an indented surface at least in portions thereof,
in such a manner that the exchange of heat with the environment is facilitated or comprises one or more protuberances or elevations one behind the other in the lengthwise direction in at least sections thereof, and in which substantially corresponding indentations, recesses or channels are located substantially diametrically opposite thereto.

20. The device of claim 14, wherein
the at least one support element comprises at least one fastening means, which can be connected to a corresponding fastening means of a second support element.

21. The device of claim 14, wherein
the selected shape memory polymer and the internal structure of the support element are configured such that for a given intensity of solar radiation the support element is heated so that the shape memory polymer of the support element assumes its second configuration and automatic erection and/or bulging and/or deployment of the device takes place.

22. The device of claim 14, wherein
the sheet material is selected from the group of materials consisting of: foil, textile, nonwoven, paper, spun fabric, polymer network, wire mesh, or gauze.

23. Use of a device of claim 14, selected from the list comprising:
polytunnels; roofing or protective wall for a market, selling or exhibition stand; protective canopy for the cultivation of ornamental or crop plants; shelter; carport; boat shelter; pool cover or pool roof; emergency accommodation; emergency garage, awning, sunscreen; shade, wind protection, hail protection, bird protection; starling protection; tent, marquee, gazebo, toolshed, storage room, covering for aviaries or runs for small animals; pond cover; composter; fence, snow fence, snow trap, and/or advertising surface for visual advertising, particularly outdoor advertising.

24. A method for producing a device of claim 14, comprising:
providing a sheet material,
attaching at least one support element to the sheet material, wherein the at least one support element comprises at least one shape memory polymer and has a substantially straight shape, and/or is present in a temporary configuration of the at least one shape memory polymer; and
rolling or folding up the sheet material that is furnished with at least one support element.

25. A device for heat-induced deformation of at least one support element of claim 14, comprising:
a first surface having at least two subareas that are pivotable with respect to one another, wherein the middle surface normals of the two subareas together form a first angle or extend parallel to one another in a first position of the two subareas, and wherein the middle surface normals of the two subareas then extend parallel to one another or then together form a second angle in at least one second position of the two mutually pivotable subareas.

26. A method for heat-induced deformation of at least one support element of the device according to claim 14 from a first shape corresponding to the permanent or temporary configuration of the shape memory polymer to a second shape, which accordingly corresponds to the temporary or permanent configuration of the shape memory polymer, comprising:
placing a plurality of support elements one on top of the other and/or side by side as a layer or stack or as a layer stack of detachably interconnected support elements having a given shape on a first area, wherein the first area has at least two subareas that are pivotable relative to one another, and the middle surface normals of which together form a first angle or extend parallel to one another;
raising the temperature of the shape memory polymer above the glass transition temperature or the softening temperature thereof, either indirectly by heating at least one of the subareas or by heating the plurality of support elements;
pivoting at least one of the two subareas relative to the other subarea such that, unlike before, the middle surface normals of the subareas now extend parallel to one another or form a second angle together that differs from a first angle;
lowering the temperature of the shape memory polymer to below the glass transition temperature or softening temperature thereof, either indirectly by cooling at least one of the subareas or by bringing the plurality of support elements into contact with a coolant, or a cool or cooled second surface or wall; and
removing the reshaped support elements from the layer or stack.
